(19) United States
(12) Patent Application Publication
(10) Pub. No.: US 2014/0041143 A1
(43) Pub. Date: Feb. 13, 2014

(54) WIPER BLADE ASSEMBLY

(71) Applicants: Kwan Hee KIM, Daegu (KR); Jae Hyuck An, Daegu (KR)

(72) Inventors: Kwan Hee KIM, Daegu (KR); Jae Hyuck An, Daegu (KR)

(21) Appl. No.: 13/606,948

(22) Filed: Sep. 7, 2012

(30) Foreign Application Priority Data
Sep. 7, 2011 (KR) 10-2011-0090723

(51) Int. Cl. B60S 1/40

(52) U.S. Cl. CPC B60S 1/40
USPC 15/250.32

(57) ABSTRACT

A wiper blade assembly for a vehicle. The present invention relates to a wiper blade assembly, and more particularly to a wiper blade assembly which can prevent lifting and chattering of a wiper blade in order to perform stable wiping when the chide is driven at a high speed. Further, the present invention provides a wiper blade assembly including an adaptor part which can be coupled with various wiper arms.

### CROSS-REFERENCE TO RELATED APPLICATIONS

This application claims the benefit of Korean Patent Application No. 10-2011-0090723, filed Sep. 7, 2011, the entirety of which is hereby incorporated by reference.

### FIELD OF THE INVENTION

The present invention relates to a wiper blade assembly, and more particularly to a wiper blade assembly equipped with a wiper blade and a connector coupled with a wiper arm of a vehicle.

### BACKGROUND OF THE INVENTION

In general, a wiper blade removes a foreign material, snow, or rain while a vehicle is driven to prevent front visibility of a driver from being interrupted, and performs a repetitive reciprocating action in a fan shape as a motor drives a link apparatus connected to a wiper arm.

A conventional wiper blade includes a lever assembly configured by connecting levers of metal materials in a tournament type. In the lever assembly, a plurality of tournament levers curve a wiper strip, so that the wiper strip having a backing plate installed therein traces a curvature of a vehicle glass.

The wiper blade has a problem in that the wiper blade lifts by an air pressure applied to a glass surface when the vehicle is driven at a high speed and chattering occurs.

Further, in order to accept various types of wiper driving arms having different standards and shapes for each kind of vehicle, conventional wiper blades have been released in a dedicated product types corresponding to the wiper driving arms.

That is, the conventional driving arm for the vehicle is largely classified into a “U” shaped clip type having a catching structure, a bayonet type fitted as a plug type, a pin type forming a protrusion in a side portion and taking a fitting structure by the protrusion, a side hole type performing a fitting coupling in a side portion of a wiper apparatus, developed by a Bosch corporation, and a top-lock type performing a coupling by a covering structure in an upper portion of the wiper apparatus, and the various types of driving arms have a limitation in that they can use only dedicated wiper apparatuses since their shapes and sizes are different from other.

### SUMMARY OF THE INVENTION

Accordingly, the present invention has been made to provide a wiper blade which can achieve standardization and an easy design of products by providing a universal adaptor part having various standards and shapes among various driving arms.

Further, the present invention provides a wiper blade assembly which can receive various connectors by enabling an adaptor part to be attachable to/removable from a wiper blade.

Moreover, the present invention provides a wiper blade assembly which can be applied to wiper driving arms having various standards and shapes and prevents lifting and chattering.

In accordance with an aspect of the present invention, there is provided a wiper blade including: a wiper strip for directly wiping a wiping surface; a lever assembly for supporting the wiper strip; and a cover part for receiving the lever assembly, wherein the cover part includes: finned sections and integrally formed with the cover part totally concavely in a direction of the wiper strip, the finned section forming a front end in an upper side of the rover part; and an adaptor part having a fitting recess approximately in a center thereof to mount the connector.

In accordance with another aspect of the present invention, there is provided a wiper blade including: a wiper strip for directly wiping a wiping surface; a lever assembly for supporting the wiper strip; and a cover part for receiving the lever assembly, wherein the cover part includes: a concave part approximately in a center thereof; and an adaptor part having a fitting recess to mount the connector, and a lower surface of the adaptor part is formed to fit the concave part, an upper surface of the adaptor part is received in a bottom surface of the connector, at least one pair of connection protrusions for connecting the adaptor part and the connector are protrudely formed in the upper surface of the adaptor part, and the fitting recess is protrudely formed approximately in a center of the adaptor part.

In accordance with another aspect of the present invention, there is provided a wiper blade assembly including: a wiper strip for directly wiping a wiping surface; a lever assembly for supporting the wiper strip; a cover part for receiving the lever assembly, the cover part including an adaptor part having a fitting recess approximately in a center thereof; and a connector including a fitted part fitted in the fitting recess of the adaptor part, and coupling parts for catching a latch of a wiper arm, wherein the cover part further includes finned sections integrally formed with the cover part totally concavely in a direction of the wiper strip, the finned sections forming a front end in an upper side of the cover part.

In accordance with another aspect of the present invention, there is provided a wiper blade assembly including: a wiper strip for directly wiping a wiping surface; a lever assembly for supporting the wiper strip; a cover part for receiving the lever assembly, the cover part including an adaptor part having a fitting recess to mount a connector; and the connector including a fitted part fitted in the fitting recess of the adaptor part, and coupling parts for catching a latch of a wiper arm, wherein the cover part having a concave part approximately in a center thereof, and the adaptor part is formed to fit the concave part, an upper surface of the adaptor part is received in a bottom surface of the connector, at least one pair of connection protrusions for connecting the adaptor part and the connector are protrudely formed in the upper surface of the adaptor part, and the fitting recess is protrudely formed approximately in a center of the adaptor part.

According to the present invention, it is possible to provide a universal wiper blade which can be applied to driving arms having various standards and shapes.

According to the present invention, it is possible to provide a wiper blade which can be applied to driving arms having various standards and shapes and prevent lifting and chattering.

### BRIEF DESCRIPTION OF THE DRAWINGS

FIGS. 1A and 1B are a front view and a perspective view of a whole configuration of a wiper blade according to the present invention.

FIGS. 2A and 2B are a front view and a perspective view of a whole configuration of the wiper blade in which an adaptor part is formed according to the present invention.

FIG. 3A is a partial perspective view of one end of a wiper strip according, to the present invention.

FIG. 3B is a partial perspective view of the other end of the wiper strip according to the present invention.

FIG. 4 is a front exploded view illustrating a cover part and a lever assembly of the wiper blade according to the present invention.

FIG. 5 is a perspective view of the cover part and the lever assembly of the wiper blade separated from each other according, to the present invention.

FIG. 6 illustrates indications in a cross section of the over part and the lever assembly of the wiper blade according to the present invention.

FIG. 7A is a cross-sectional view illustrating a cross section in an axis direction of VC in FIG. 6.

FIG. 7B is a cross-sectional view illustrating a cross section in an axis direction of VB in FIG. 6.

FIG. 7C is a cross-sectional view illustrating a cross section in an axis direction of VA in FIG. 6.

FIG. 7D is a cross-sectional view illustrating a cross section in an axis direction of IVC in FIG. 6.

FIG. 7E is a cross-sectional view illustrating a cross section in an axis direction of IVB in FIG. 6.

FIG. 7F is a cross-sectional view illustrating a cross section in an axis direction of IVA in FIG. 6.

FIGS. 8A, 8B, and 8C are a plane view, a front view, and a cross-sectional view of a connection holder part of the wiper blade according to the present invention.

FIGS. 9A and 9B are perspective views of the wiper blade equipped with a wiper arm according to the present invention.

FIG. 10A is a perspective view of an adaptor part of the wiper blade in a first embodiment according to the present invention.

FIG. 10B is a cross-sectional view of the adaptor part of the wiper blade illustrate in FIG. 10A in a horizontal direction.

FIG. 11A is a perspective view of an adaptor part of the wiper blade in a second embodiment according to the present invention.

FIG. 11B is a cross-sectional view of the adaptor part of the wiper blade illustrated in FIG. 11A in a horizontal direction.

FIGS. 12A and 12B are perspective views of an adaptor part of the wiper blade in a third embodiment according to the present invention.

FIGS. 13A and 13B are perspective views of an adaptor part of the wiper blade in a fourth embodiment according to the present invention.

FIG. 13C is a perspective view of the adaptor part of the wiper blade, viewed from the bottom, in the fourth embodiment according to the present invention.

FIG. 14A is a perspective view of the connector in a first embodiment according, to the present invention.

FIG. 14B is a perspective view of a rotated head part of the connector in the first embodiment according to of the present invention.

FIG. 14C is a perspective view illustrating a state where a connector body and a head part cover of the connector in the first embodiment according to the present invention are separated from each other.

FIG. 14D is a rear view of the connector in the first embodiment according to the present invention.

FIGS. 15A and 15B are perspective views illustrating that the wiper arm is coupled to the connector in the first embodiment according to the present invention.

FIG. 16A is a perspective view of the connector in a second embodiment according to the present invention.

FIG. 16 is a plane view of the connector in the second embodiment according to the present invention viewed from the top.

FIG. 16C is a rear view of the connector in the second embodiment according to the present invention.

FIG. 16D is a perspective view of the connector, viewed from the bottom, in the second embodiment according to the present invention.

FIGS. 17A to 17C are perspective views illustrating the wiper blade assembly according to embodiments of the present invention.

### DETAILED DESCRIPTION OF THE INVENTION

The following detailed description of the present invention shows a specified embodiment of the present invention and will be provided with reference to the accompanying drawings. The embodiment will be described in enough detail that those skilled in the art are able to embody the present invention. It should be understood that various embodiments of the present invention are different from each other and need not be mutually exclusive. For example, a specific shape, structure and properties, which are described in this disclosure, may be implemented in other embodiments without departing from the spirit and scope of the present invention with respect to one embodiment. Also, it should be noted that positions or placements of individual components within each disclosed embodiment may be changed without departing from the spirit and scope of the present invention. Therefore, the following detailed description is not intended to be limited. If adequately described, the scope of the present invention is limited only by the appended claims of the present invention as well as all equivalents thereto. Similar reference numerals in the drawings designate the same or similar functions in many aspects.

Hereafter, exemplary embodiments of the present invention will be described in detail with reference to the accompanying drawings in order that the present invention may be easily implemented by those skilled in the art.

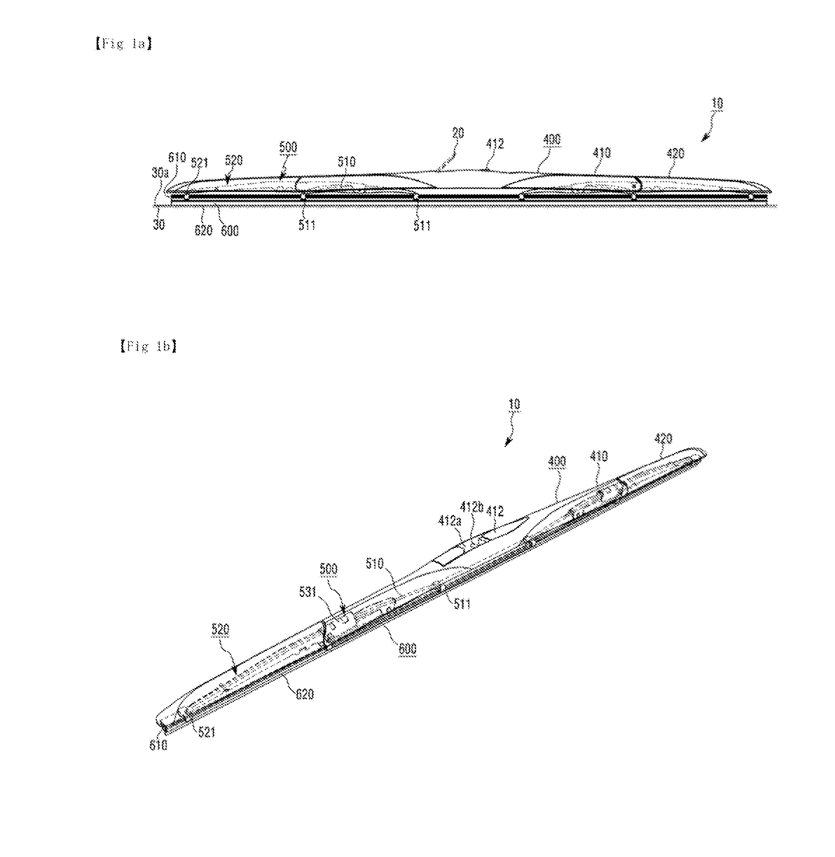

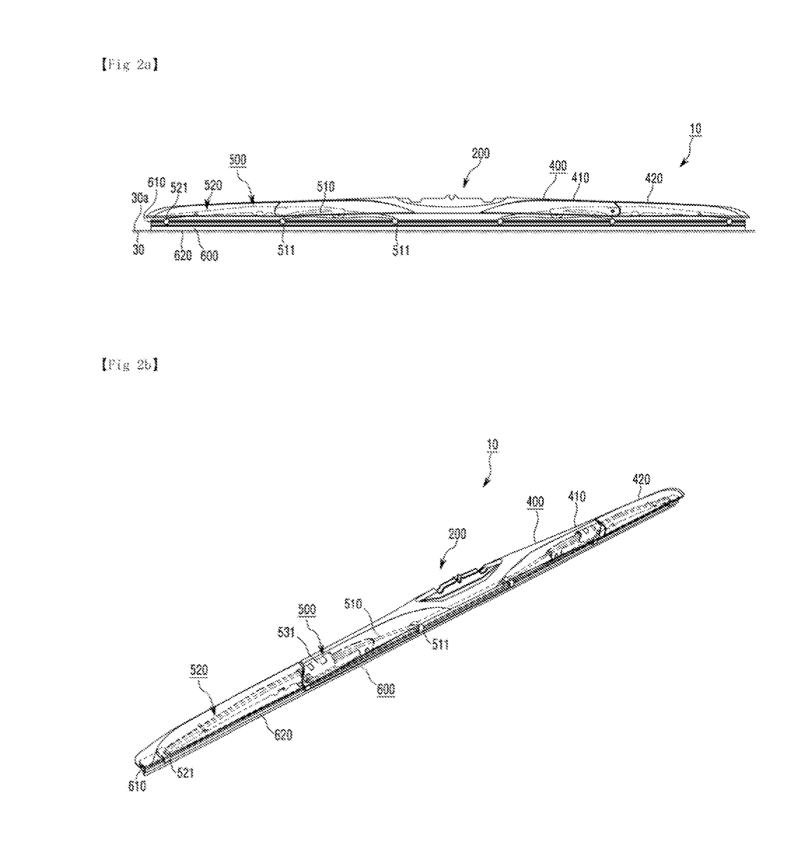

FIGS. 1A and 1B are front view and a perspective view illustrating an embodiment including some characteristics of a wiper blade according to the present invention.

Referring to FIGS. 1A and 1B, a wiper blade 10 according to the present invention includes an adaptor part 200 (not shown in FIGS. 1A and 18) connected with a connector 300 (not shown in FIGS. 1A and 1B) provided at an upper end of the wiper blade 10 and configured to fixedly support an end portion of a wiper arm 20, a wiper strip 600 coming into contact with a window glass surface of a vehicle to wipe the window glass surface of the vehicle, a plurality of lever assemblies 500 connected to each other in a tournament type and configured to support the wiper strip 600, and a cover part 400 for receiving the lever assemblies 500.

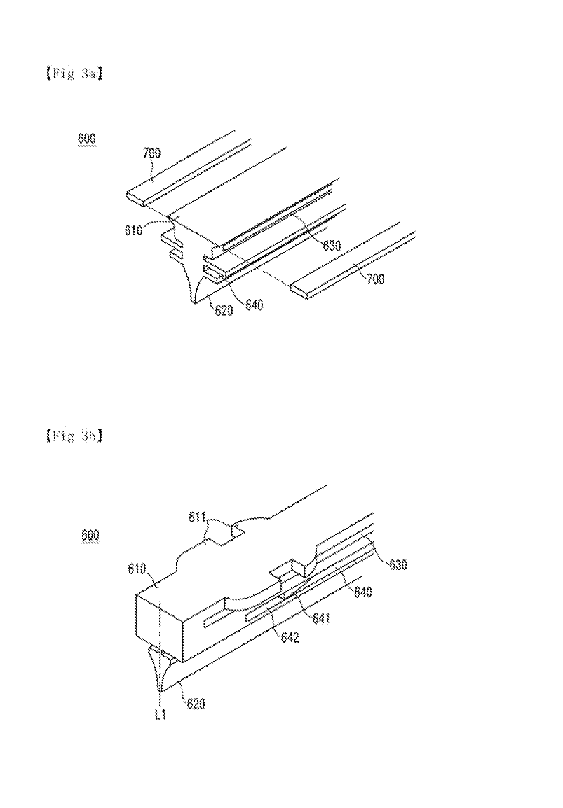

FIGS. 2A and 2B are a front view and a perspective view of the wiper blade in another embodiment according to the present invention.

Referring to FIGS. 2A and 2B, the adaptor part 200 is provided at the vicinity of a center of the cover part 400 of the wiper blade of FIGS. 1A and 1B. The connector 300 is mounted to the adaptor part 200, which will be described below in detail, and the connector 300 receives a front end of the wiper arm 20.

Hereinafter, the wiper blade illustrated in FIGS. 1A and 1B will be described in detail.

The wiper blade 10 is connected to the front end of the wiper arm 20 through the connector 300 (not shown in FIGS. 2A and 2B), and receives pressurizing force from the wiper arm 20 against a glass surface 30a of a vehicle glass 30. The wiper arm 20 is reciprocately rotated at a predetermined angle by a wiper motor (not shown), and the wiper blade 10 performs a wiping action from the glass surface 30a (wiping surface) within a predetermined angle.

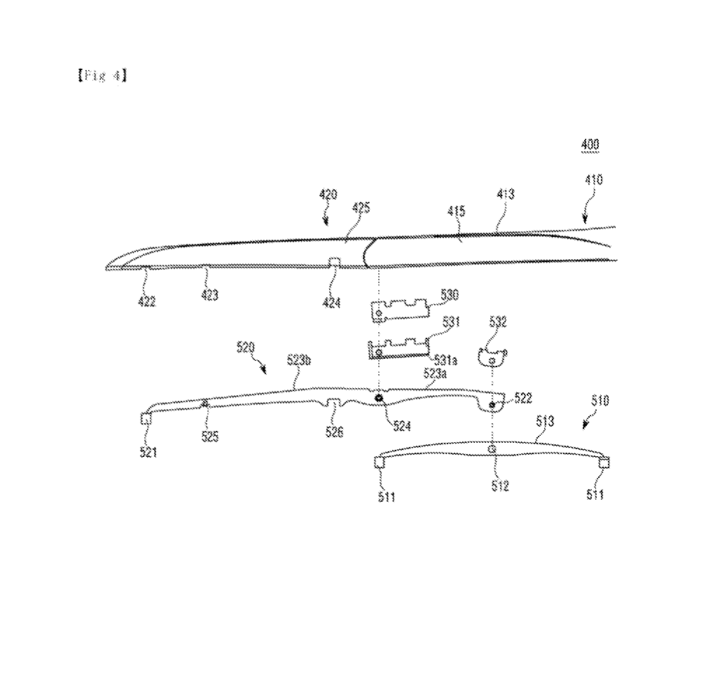

FIGS. 3A and 3B are partial perspective views of one end and the other end of the wiper strip 600, respectively.

As illustrated in FIGS. 1A, 1B, 3A, and 3B, the wiper blade 10 further includes two backing plates 700 mounted to the wiper strip 600. The lever assembly 500 includes two first levers 510 and two second levers 520.

Referring to FIGS. 1A, 1B, 3A, and 38, the wiper strip 600 includes a wiping lip part 620 directly coming into contact with the glass surface 30a to perform the wiping action, and a base part 610 supported by the lever assembly 500. The wiper strip 600 is disposed to slidably come into contact with the glass of the vehicle and removes a foreign material from a surface of the glass. The wiper strip 600 extends in a length direction lengthily and is made of an elastic material such as a rubber material or an elastic synthetic material.

Referring to FIGS. 3A and 3B, the base part 610 is supported by fasteners 511 and 521 of a first lever 510 and a second lever 520 of the lever assembly 500. The fasteners 511 and 521 may be a yoke type. The base part 610 and the wiping lip part 620 continuously extend in a length direction of the wiper strip 600. A receiving groove for receiving the two backing plates parallel to each other in the length direction extends on the base part 610. The two backing plates 700 corresponding to rectangular metal material plates having spring properties are received in two backing plate receiving grooves 630, respectively. A holding part 640 is a part for receiving the fasteners 511 and 521 in a sliding type.

The holding part 640 at one end of the wiper strip 600 illustrated in FIG. 3A is an open type capable of receiving the fasteners 511 and 521, but the other end illustrated in FIG. 3B is formed to restrict a length direction movement of the second fastener 521 of the second lever. That is, one of the second fasteners 521 of the second lever 520 is restricted by a wall of a slope 641 and a coupling part 642 provided only at the other end of the holding part 640. Further, the length direction movement of the second fastener 521 is restricted by a protrusion part 611.

The backing plate 700 applies elasticity and stiffness to the wiper lip pan 620. When pressurizing force is applied from the wiper arm 20, the pressurizing force is distributed to the wiper strip 600 through the lever assembly 500. At this time, the pressurizing force spreads in the length direction of the wiper strip 600 by the backing plate 700. Accordingly, the backing plate 700 should have elasticity and stiffness to maintain a shape of the wiper strip 600. The number of backing plates 700 and backing plate receiving grooves 630 may be two or more according to a degree of stiffness or elasticity of the wiper strip.

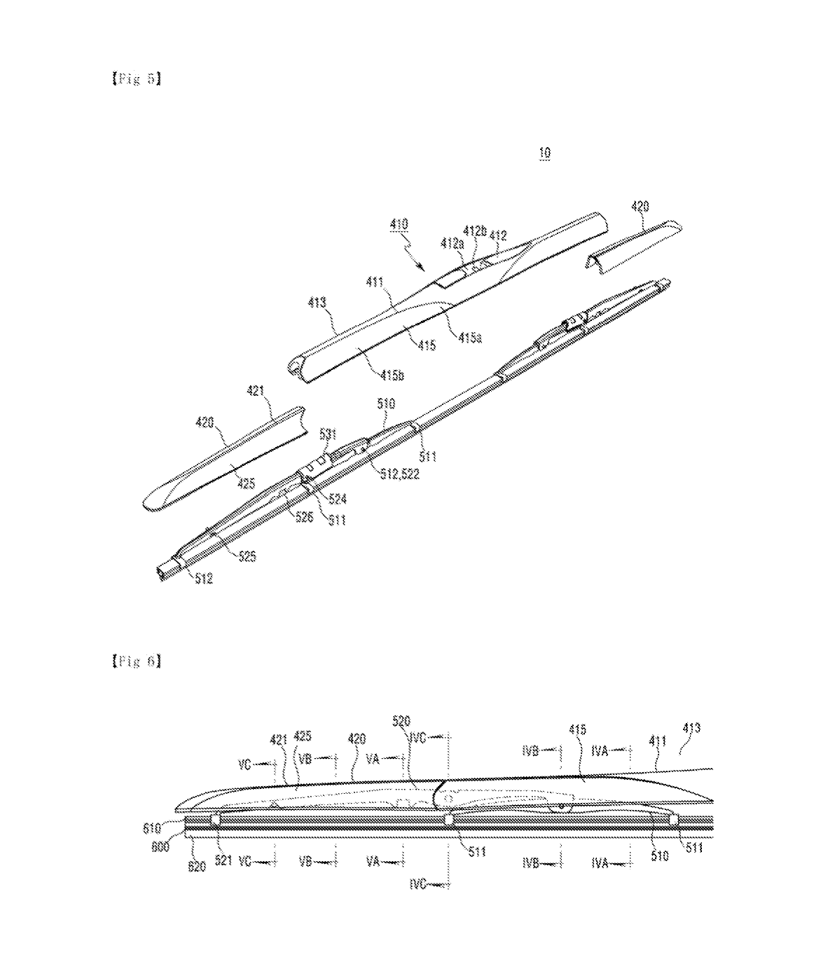

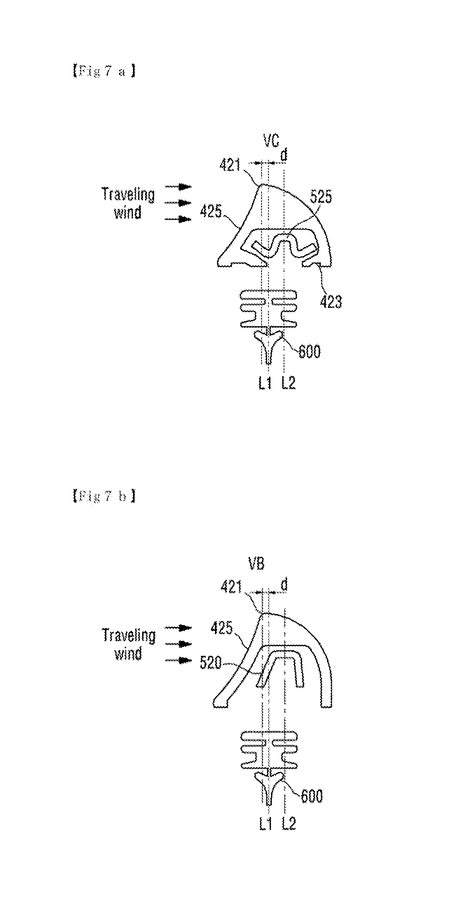

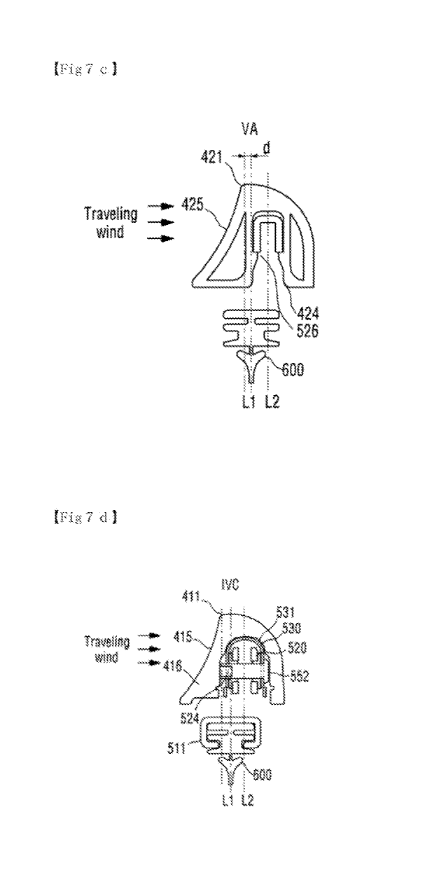

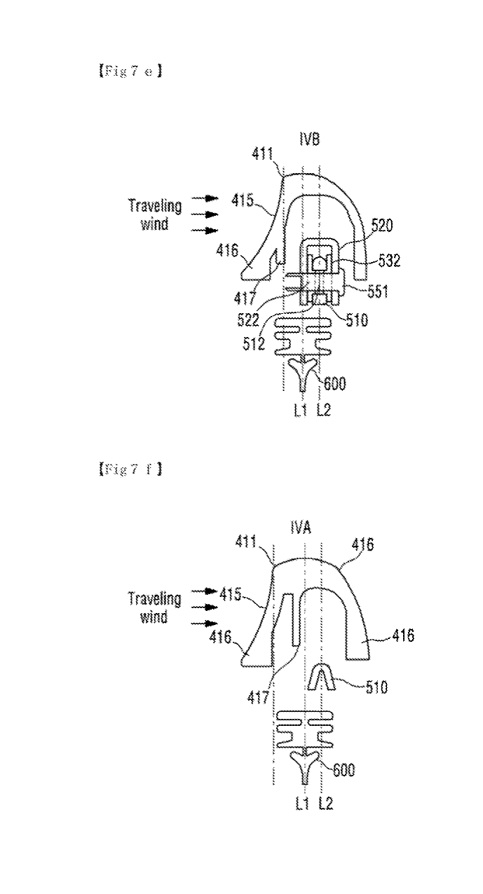

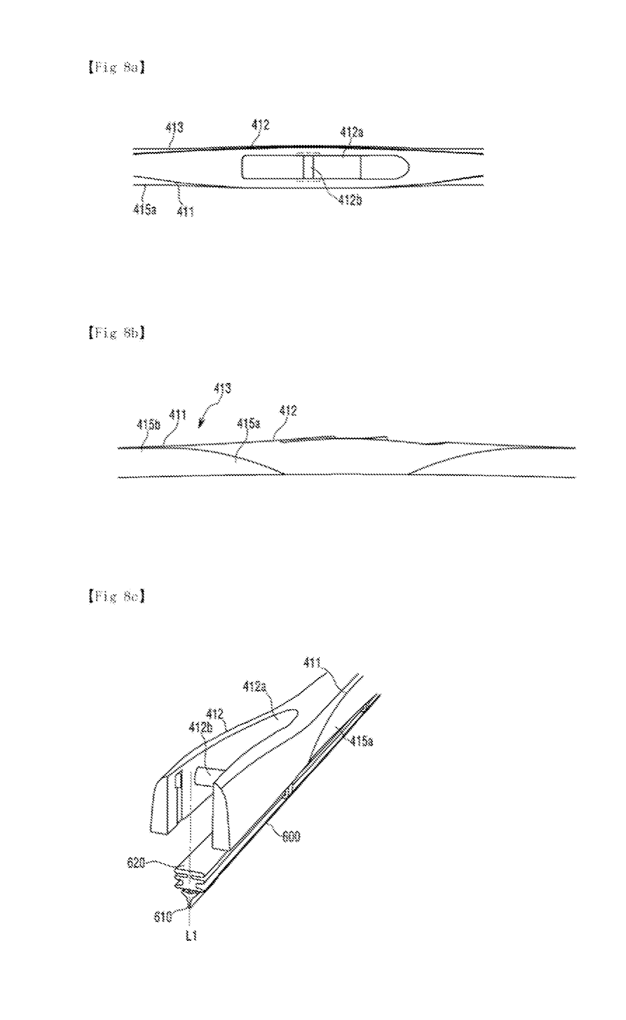

FIG. 4 is a front exploded view of the cover pan and the lever assembly of the wiper blade according to the present invention. FIG. 5 is a perspective view of the cover part and the lever assembly of the wiper blade separated from each other according to the present invention.

Referring to FIGS. 1A, 1B, 4, and 5, according to an embodiment of the present invention, the lever assembly 500 includes a pair of first levers 510 and a pair of second levers 520 hinge coupled to the first levers 510 and coupled to the cover part 400.

As illustrated in FIG. 4 in more detailed, the first lever 510 is coupled to a wiper center direction front end of the second lever 520, and hinge coupled to rotate about a coupling axis of the first lever 510.

According to the embodiment of the present invention, the first lever 510 may be provided at a position spaced apart from a center of the wiper blade 10 by a predetermined distance. One end of the second lever 520 may be hinge coupled to the first lever 510 and the other end of the second lever 520 may be coupled to the cover part 400.

The first lever 510 supports the base part 610 of the wiper strip 600. According to the embodiment of the present invention, the first lever 510 slidably supports the base part 610 of the wiper strip 600.

Each of the pair of the first levers 510 includes two first fasteners 511, two first through holes 512, and two arm parts 513.

The first lever 510 is formed to have a mountain fold extending in a length direction by press-processing a metal plate. The first lever 510 is formed to have an arch shape of which a center is convex toward the cover part 400. A lower side of the first lever 510 is formed to have an open U-shaped cross section.

The first through hole 512 of the first lever 510 may be formed in the center of the first lever 510 for a hinge coupling with the second lever 520.

The first through hole 512 is opened in a width direction of the first lever. The first through hole 512 is a part connected with a second through hole 522 of the second lever 520 described below. The first fastener 511 for supporting, the wiper strip 600 is formed in both ends of the first lever 510. The first fastener 511 slidably supports the wiper strip 600. As illustrated in FIG. 7D showing a cross section in an axis direction of IVC in FIG. 5, a center line of the first fastener 511 in a horizontal direction corresponds to a center line L1 of the wiper strip 600 in the horizontal direction. Referring to FIGS. 7D, 7E, and 7F, a center line L2 of the first lever 510 in the horizontal direction is offset from the L1. The first fastener 511 of the first lever 510 may have a yoke shape.

The second lever 520 transfers the pressurizing force by the wiper arm 20 to the first lever 510. Further, the second lever 520 supports the wiper strip 600. The second lever 520 is coupled with the cover part 400 to maintain a whole shape of the wiper blade 10.

As illustrated in FIGS. 4 and 5, the second lever 520 includes the second fastener 521 for supporting the wiper strip 600, the second through hole 522 for a hinge coupling with the first lever 510, two arm parts 523a and 523h, a third through hole 524 for a coupling with the center cover part 410, a first receiving part 525 for a coupling with a side spoiler 420 of the cover part 400, and a second receiving part 526.

The second lever 520 is formed in an arch shape toward the cover part 400. A lower side of the second lever 520 is formed to have an open U-shaped cross section. The arm part 523 includes the wiper center direction arm part 523a and the front end direction arm part 523b.

The center direction arm part 523a of the second lever 520 has the second through hole 522 formed therein to be hinge coupled with the first lever 510. The second through hole 522 may be formed in one end of the second lever 520.

The first receiving part 525 and the second receiving, part 526 for the coupling with the cover part 400, and the second fastener 521 for supporting the wiper strip are formed in the front direction arm part 523b of the second lever 520. A center line of the second fastener 521 in the horizontal direction corresponds to the center line L1 of the wiper strip 600 in the horizontal direction, similarly as the first fastener 511 of the first lever 510. The center line 12 of the second lever 520 in the horizontal direction is offset from the L1. The second fastener 521 may have the yoke shape. Further, the third through hole 524 for the hinge coupling with the cover part 400 is formed in the second lever 520.

As illustrated in FIG. 4, the second lever 520 may further include a first spacer 530 for a coupling with the cover part 400 and a spacer clip 531. The third through hole 524 may be formed in the axially same position as that of the first fastener 511 in the front end of the first lever 510.

FIG. 6 is a perspective view of an entire surface of the cover part 400, the lever assembly 500, and the wiper strip 600 of the wiper blade 10 coupled with each other.

The cover part 400 is a means for receiving the lever assembly 500 and improving adhesion to the glass surface 30a of the wiper strip 600 by distributing the pressurizing force from the wiper arm 20 to the lever assembly 500

As illustrated in FIGS. 4, 5, and 6, the cover part 400 includes the center cover part 410 and the two side spoilers 420. The cover parts 410 and 420 include finned sections 415 and 425 according to the present invention, and a center finned section upper front end 411 corresponding to an upper front end of the finned section 415 formed in the center cover part 410 and a side upper front end 421 corresponding to an upper front end of the finned section 425 formed in the side spoiler 420 configure an upper front end of the finned section of the coverage part 400.

The side spoilers 420 are located in both ends of the center cover part 410, respectively. The center cover part 410 and the side spoiler 420 are made of a synthetic resin, respectively, and have predetermined stiffness.

Further, the center cover part 410 and the side spoiler 420 are coupled with each other to configure the cover part 400, and the cover part 400 extends in a length direction of the wiper blade 10. A length of the length direction of the cover part 400 is longer than a length of a length direction of the lever assembly 500. The cover part 400 is integrally formed with the wiper strip 600 externally.

Referring to FIGS. 1A, 1B, 2A, 2B, 4, 5, 8B, and 8C, the center cover part 410 includes the center finned section upper front end 411, a connection holder part 412 for a connection with the wiper arm 20, a pair of first lever cover parts 413, and a pair of finned sections 415.

As illustrated in FIG. 5, the connection holder part 412 is located approximately in a center of the center cover part 410, a lower portion of the connection holder part 412 does not receive the lever assembly 500, and an opening 412a for a coupling with the wiper arm 20 or the adaptor part 200 as illustrated in FIGS. 2A and 2B may be formed in the connection holder part 412.

The lever cover parts 413 are disposed in both ends of the connection holder part 412 so as to cover the whole first lever 510.

Since the center cover part 410 is formed to have the arch shape convex toward the wiper arm 20, the wiper strip 600 comes into contact with the glass surface of the vehicle indirectly applying external force to the lever assembly 500.

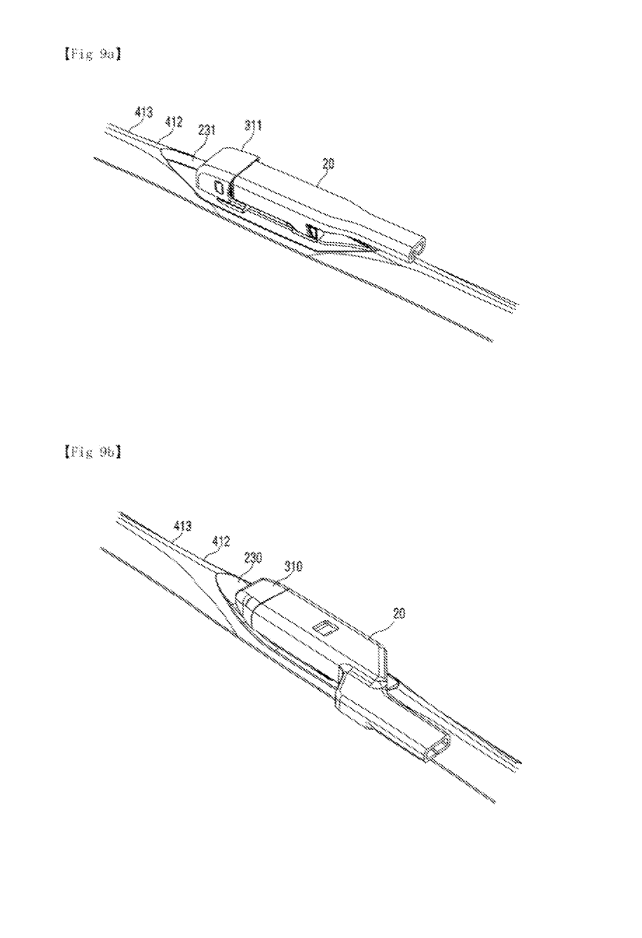

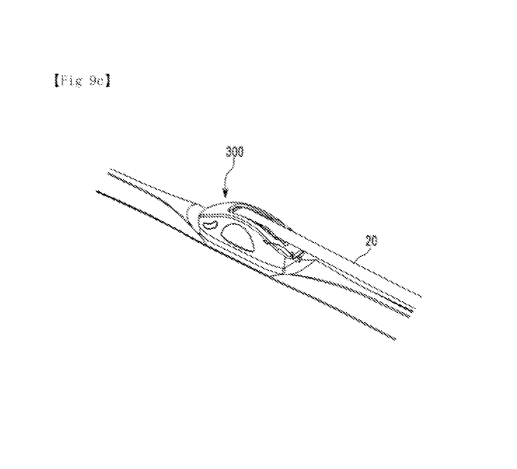

FIGS. 8A, 8B, and 8C are a plane view, a front view, and a cross-sectional view of the connection holder part of the wiper blade according to the present invention.

As illustrated in FIGS. 5, 8A, 8B, and 8C, the connection holder part 412 does not receive the lever of a metal material therein, that a degree of freedom of a shape is increased. That is, it is easy to provide the adaptor part 200 (not shown) considering the shape of the connector 300 (not shown) at the connection holder part 412. Further, an exterior of the center cover part 410 may have the finned section 415 so as to efficiently distribute pressurizing force according to traveling wind when the vehicle is driven to the whole wiper blade 10. The finned section 415 spreads air flows to the front end of the cover part 400 to prevent the wiper blade 10 from lifting.

FIGS. 7A to 7F are cross-sectional views illustrating cross sections in axis directions with respect to VC, VB, VA, IVC, IVB, and IVA of FIG. 6.

Referring FIGS. 7D, 7E, and 7F, a thickened portion 416 is installed in each internal vertex of a cross section of the center cover part 410. Accordingly, the center cover part 410 increases resistance and stiffness for a twisting moment. A rib 417 is provided at an interior of the center cover part 410 to prevent clearance of internal structures.

Referring to FIGS. 5A and 8C, the connection holder part 412 is formed to have parallel walls, and a center of the connection holder part 412 in the horizontal direction corresponds to the center line L1 of the wiper strip 600 in the horizontal direction. A vehicle front exterior of the connection holder part 412 may include a connection holder part finned section 415a in a lower portion thereof. An upper front end of the connection holder part finned section 415a configures a part of a curve that meets the center finned section upper front end 411 corresponding to the upper front end of the cover part 400 as the upper front end of the connection holder part finned section 415a is closer to both ends of the wiper blade 10 starting from a lower end portion of the connection holder part 412.

The adaptor part 200 (not shown), which can be coupled with the connector 300 (not shown), is provided at an interior of the connection holder part 412 in a front side of the vehicle. Edges of the opening 412a of the connection holder part 412 are formed in a type having a curvature, and transfer stress concentrated in the opening 412a of the connection holder part 412 to the first lever cover part 413 of the center cover part 410.

Referring to FIG. 8A, the connection holder part 412 is rotatably connected to the front end of the wiper arm 20 through a connection clip 412a.

Referring to FIGS. 7E, 7F, 8A, and 8B, the first lever cover parts 413 are located in both ends of the center cover part 410 and extend in the length direction of the wiper blade. The first lever cover part 413 has an open part in a lower portion thereof, and the open part is formed in a U shape to receive the first lever 150. The finned section 415 of the center cover part 410 includes the finned section 415a formed in the connection holder part and the tinned section 415b formed in the first lever cover part 413. The connection holder part finned section 415a and the first lever cover part finned section 415b integrally configure the finned section 415 of the center cover part. The connection holder part tinned section 415a is formed in the connection holder part 412 of the wiper blade 10 to spread traveling wind from a front side of the vehicle from side to side. The finned sections 415a of the connection holder part 412 extend to both front ends of the wiper blade 10 from the lower portion of the connection holder part 412, respectively. The first lever cover part finned section 415b is formed in the first lever cover part 413, and allows the traveling, wind, to flow from side to side or in a top direction. The center finned section upper front end 411 corresponding to the upper front end of the first lever cover part finned section 415b has a shape offset from the center line L1 of the wiper strip 600 in the horizontal direction with a predetermined distance therebetween.

The first lever cover part 413 is integrally formed with the finned section 415. The finned section 415 for generating pressurizing force pressurizing the wiper strip 600 against the glass surface 30a by receiving, the traveling wind applied to the driven vehicle is formed to be a slope.

Referring to FIGS. 4, 5, 6, 7A, 7B, and 7C, the side spoiler 420 is a part for receiving at least a part of the second lever 520. The side spoiler 420 has an open part in a lower portion thereof, and the open part is formed in a U shape to receive the second lever 520. The side finned section upper front end 421 corresponding to the upper front end of the finned section 425 of the side spoiler 420 has a shape offset at one side of the center line L1 in the horizontal direction from the center line L1 of the wiper strip 600 in the horizontal direction with a predetermined distance therebetween.

The side spoiler 420 includes the side finned section extending from the finned section 415b of the first lever cover part 413. The side spoiler 420 receives the front end direction arm part 523b of the second lever 520.

The side finned section 425 extends from the side tinned section upper front end 421 offset from the center line of the wiper blade 10. The side finned section upper front end 421 of the side spoiler 420 corresponds to the upper front end of the side spoiler 420. The side finned section upper front end 421 is offset from the center line L1 of the wiper strip 600 in a front direction of the vehicle in order to enable the side spoiler 425 to receive the second lever 520. Further, the offset of the finned section 425 is constantly maintained along the front end of the side spoiler 420. The traveling wind flows to a top side of the wiper blade 10. Accordingly, the lifting of the wiper blade 10 and the chattering are prevented.

Referring to FIG. 4, the side spoiler 420 includes a support protrusion 422 for supporting the second lever 520. An upper portion of the second fastener 521 of the second lever 520 is supported by the support protrusion 422 of the side spoiler 420. The support protrusion 422 prevents deformation by a moment of the second lever 520 by preventing the second fastener 520 of the second lever 520 from rotating, in a direction of the side spoiler 420. Further, the side spoiler 420 includes a first coupling protrusion 423 and a second coupling protrusion 424 for integrally coupling the second lever 520 and the side spoiler 420 and preventing the second lever 520 from being, separated from the side spoiler 420.

Referring to FIGS. 4, 5, 7A, and 7C, the side finned section 425 is integrally formed on an upper portion surface of the side spoiler 420. More specifically, the finned section 425 is implemented by a shape change of the upper portion surface of the side spoiler 420. The finned section 425 acts to induce an air flow so that air moving to a glass side of the vehicle pressurizes the side spoiler 420 in a direction closer to the vehicle glass 30 when an wiping, action is performed. As illustrated in FIG. 7A, the first coupling protrusion 423 may be formed to inwardly protrude from a bottom portion of the side spoiler 420, and may form a space for receiving the second lever 520. A lower end of a first receiving pan 525 of the second lever 520 may be formed to be outwardly bent in order to be coupled with and received in the formed space. Accordingly, the first receiving part 525 is hooked on the first coupling protrusion 423, and thus the second lever 520 is prevented from being separated from the side spoiler 420. As illustrated in FIGS. 7B and 7C, a horizontal direction width of the front end direction arm part 523b of the second lever 520 is wider than a horizontal direction width of the second receiving part 526. That is, the second protrusion 424 of the side spoiler 420 is elastically coupled with the second receiving part 526 by horizontally pressurizing the second receiving part 526 of the second lever 520, and prevents the second lever 520 from being separated from the side spoiler 420.

Embodiments of the adaptor part according to the present invention will be hereinafter described.

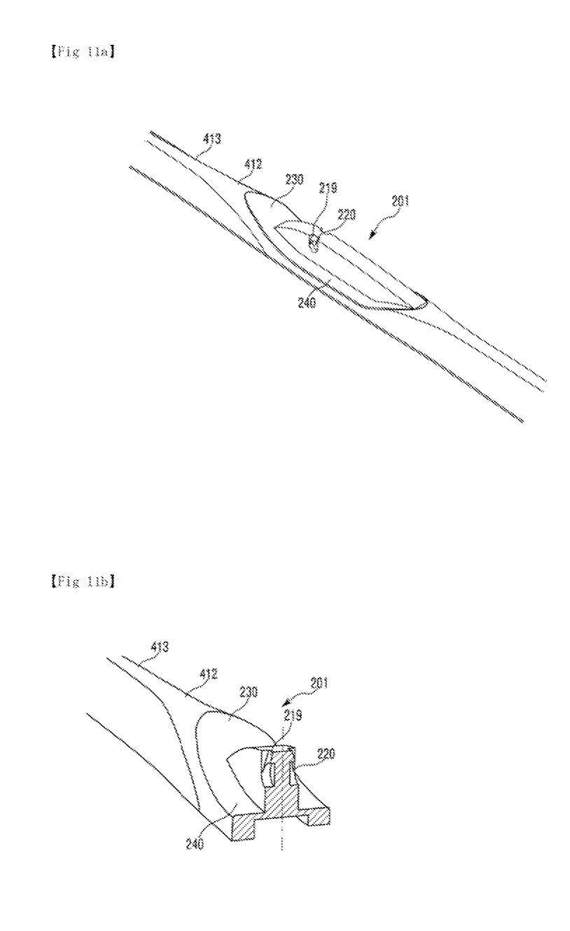

FIG. 10A is a perspective view of the adaptor unit of the wiper blade in a first embodiment according to the present invention.

Referring to FIG. 10A, the adaptor unit 200 according to the present invention includes center parts 212 and a pair of front ends 232. The center part 212 may include an fitting recess 222 formed in a center of the center part 212 and connected to the connector 300, and a first receiving groove 223 and a second receiving groove 224 meeting with a lower portion of the connector 300.

The adaptor part 200 is formed in a concave part 242 located approximately in a center of the connection holder part 412 of the cover part 400. It is preferable that the concave part 242 is formed in a trapezoidal shape of which a width becomes narrower in a direction of the wiper strip 600 so that the connection holder part tinned section 415a corresponding to a part of the center finned section 415 of the wiper blade is connected with a lower end portion of the connection holder part 412. However, the concave part 242 is not limited to the trapezoidal shape, and may be formed in a U shape. A lower surface of the adaptor part 200 is formed to fit the concave part 242.

As illustrated in FIGS. 5 and 8B, the connection holder part 412 includes the finned section 415a extending in a direction of both front ends of the wiper blade 10 from a lower portion thereof. The connection holder part finned section 415a configures the center finned section 415 of the center cover part 410 together with the first lever cover part finned section 415b formed in the first lever cover part 413. The connection holder part tinned section 415a spreads pressurizing force to the whole wiper blade 10 by making pressure of traveling wind applied to the wiper blade when the vehicle is driven flow right and left.

Accordingly, the adaptor part 200 is formed in the connection holder part 412 including the finned part 415a. Further, since the adaptor part 200 is integrally formed with the cover part 400, the adaptor part 200 is made of the same resin material as that of the cover part 400. Therefore, in order to secure stiffness, the lower portion of the adaptor 200 is formed in a closed type instead of an open type.

FIG. 10B is a horizontal cross-sectional view of tlhe adaptor part 200 illustrated in FIG. 10A.

As illustrated in FIG. 10B, the center parts 212 are formed to vertically protrude while facing each other with respect to an axis corresponding to a horizontal direction center of the wiper blade. The center parts 212 may be formed of a pair of plate-shaped members. The first receiving groove 223 and the second receiving groove 224 meeting the lower end portion of the connector 300 are formed in both ends of the center pan 212. The fitting recess 222 for a coupling with the connector 300 is formed in the center of the center part 212.

As illustrated in FIG. 10B, the center parts 212 are formed to be symmetric with respect to the horizontal direction center of the wiper blade. That is, the fitting recesses 222, the first receiving grooves 223, and the second receiving grooves 224 are formed to be symmetric with respect to the horizontal direction center of the wiper blade 10. The fitting recess 222 is firmed to have a circular groove shape in a length direction center of the wiper blade 10.

The front end 232 is formed in both ends of the adaptor part 200, and connected with each of the first receiving groove 223 and the second receiving groove 224. The front end 232 may be formed to maintain a predetermined height from the connection holder part 412.

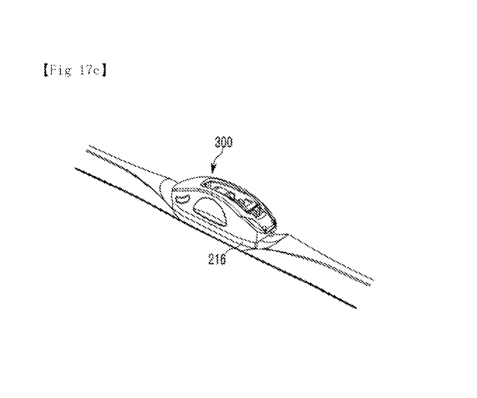

FIG. 17A illustrates a wiper blade assembly with the adaptor part 200 and the connector 300.

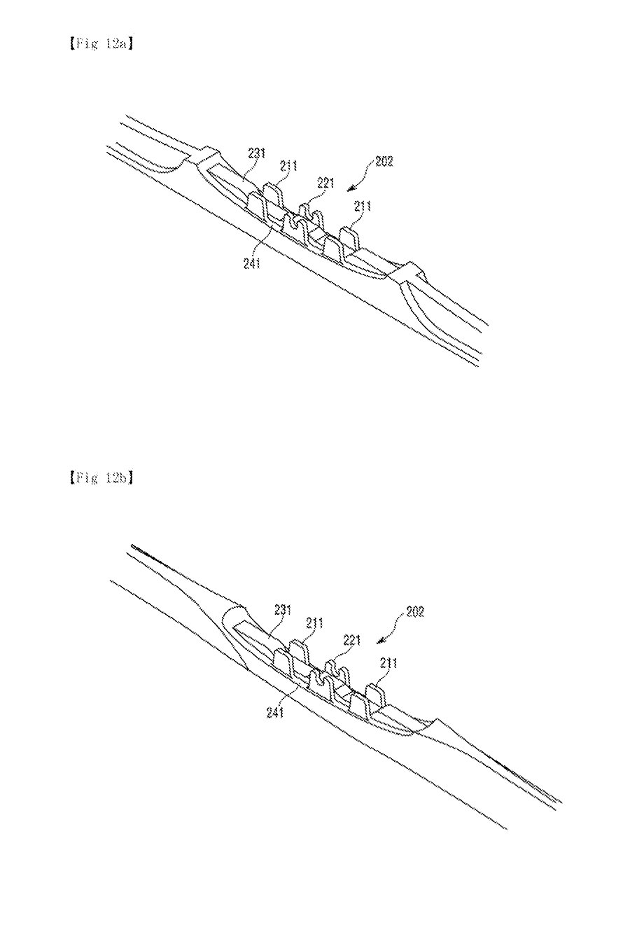

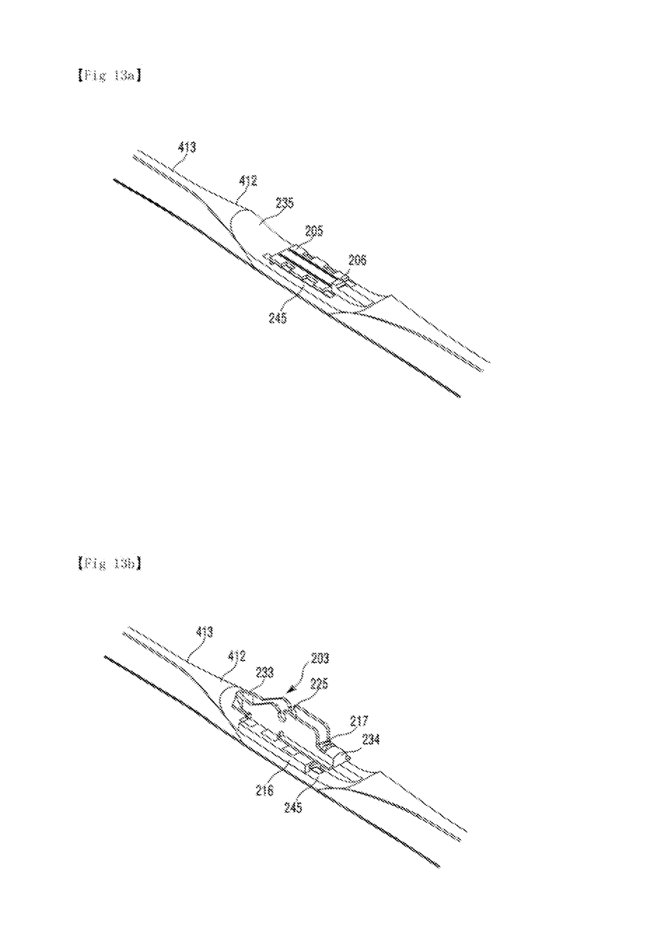

FIG. 11A is a perspective view of an adaptor part of the wiper blade in a second embodiment according to the present invention.

Referring to FIG. 11A, an adaptor part 201 is formed in the center of the cover part, and includes the fitting recess 220 connected with the connector 300.

The adaptor part 201 is formed in a concave part 240 located approximately in the center of the connection holder part 412. It is preferable that the concave part 240 is formed in a trapezoidal shape of which a width becomes narrower in a direction of the wiper strip 600 so that the connection holder part finned section 415a corresponding to a part of the center finned section 415 of the wiper blade is connected with the lower end portion of the connection holder part 412. However, the concave part 240 is not limited to the trapezoidal shape, and may be formed in a shape. In this embodiment, the adaptor part 201 is not required to be formed to fit the concave part 240.

As illustrated in FIGS. 5 and 8B, the connection holder part 412 includes the finned section 415a extending in a direction of both front ends of the wiper blade 10 from a lower portion thereof. The connection holder part finned section 415a configures the center finned section 415 of the center cover pan 410 together with the first lever cover part finned section 415b formed in the first lever cover part 413. The connection holder part finned section 415a spreads pressurizing force to the whole wiper blade 10 by making pressure of traveling wind applied to the wiper blade when the vehicle is driven flow right and left.

Accordingly, the adaptor part 201 is formed in the connection holder part 412 including the finned part 415a. Further, since the adaptor part 201 is integrally formed with the cover part 400, the adaptor part 200 is made of the same resin material as that of the cover part 400. Therefore, in order to secure stiffness, the lower portion of the adaptor 201 is formed in a closed type instead of an open type.

The adaptor part 201 is integrally formed with the cover part 400, and upwardly protrudes. Since he adaptor part 201 is integrally formed with the wiper blade 10, stiffness of the wiper blade 10 is increased. One end of the adaptor part 201 meets inclined one end 230 of the concave part 240, and the other end of the adaptor part 201 may be connected with an upper surface of the cover part 400. The other end of the adaptor part 201 may have a step with the cover part 400.

As another embodiment, both ends of the adaptor part 201 may be formed to meet inclined surfaces formed in both ends of the concave part 240.

FIG. 11B is a horizontal cross-section view of the adaptor part 201 of the wiper blade 10 in the second embodiment according to of the present invention.

As illustrated in FIG. 11B, the fitting recess 220 is formed to be symmetric with respect to the horizontal direction center of the wiper blade 10. The fitting recess 220 is formed to have a circular shape in the vicinity of the length direction center of the wiper blade 10. A guide recess is formed in the adaptor part 201 to insert the connector 300 in the fitting recess 220. The guide recess 219 may form a slope of which a horizontal direction width is increased toward the fitting recess 220 from an upper portion of the adaptor part 201. Accordingly, a coupling with the connector 300 is easily achieved, and the connector 300 is not easily separated.

Both ends of the concave part 240 are downwardly inclined toward the center from the connection holder part 412, and a slope may be a straight line or a curve. A head part 310 of the connector 300 may be provided at one side of both ends 230 of the concave part 240. A cover 310b of the connector 300 is guided along the slope of one end 230 of the concave part 240, and can move forwardly and backwardly.

According to a shape of the connector 300, all front ends of both sides of the adaptor part 200 may be connected to an upper surface of the cover part 400. FIG. 17B illustrates the wiper blade assembly in which the connector 300 is mounted to the adaptor part 201.

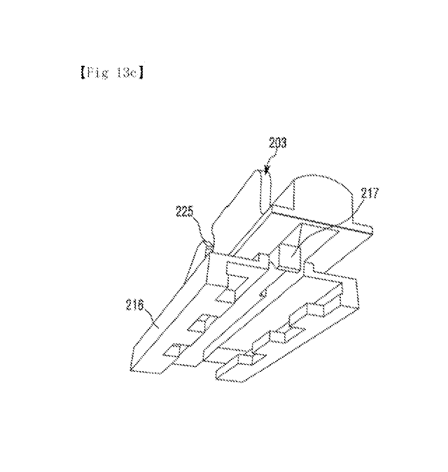

FIGS. 12A and 12B are perspective views of an adaptor part of the wiper blade in a third embodiment according to the present invention.

Referring to FIG. 12A, an adaptor part 202 is formed in a concave part 241 located approximately in a center of the connection holder part 412 of the cover part 400. It is preferable that the concave part 241 is formed in a trapezoidal shape of which a width becomes narrower in a direction of the wiper strip 600 so that the connection holder part finned section 415a corresponding to a part of the center finned section 415 of the wiper blade is connected with the lower end portion of the connection holder part 412. However, the concave part 241 is not limited, to the trapezoidal shape, and may be formed in a U shape. A lower surface of the adaptor unit 202 is formed to fit the concave part 241.

Since the adaptor part 202 is integrally formed with the cover part 400, the adaptor part 200 is made of the same resin material as that of the cover part 400. Therefore, in order to secure stiffness, the lower portion of the adaptor 202 is formed in a closed type instead of an open type.

Referring to FIG. 12A, an upper portion of the adaptor part 202 may include two pairs of connection protrusions 211 and a pair of fitting recesses 221 facing with respect to an axis corresponding to a horizontal direction center line L1 of the wiper strip 600 and vertically protruding in a length direction with a predetermined interval therebetween. The adaptor part 202 includes a pair of connection protrusions 211, the fitting recess 221, and a front end 231. The connection protrusion 211 is received in a bottom of the connector 300 to mount the connector 300 to the adaptor part 202. The fitting recess 221 is a part coupled with the connector 300 and hinged by the wiper arm. The front ends 231 are symmetrically formed in both front ends of the connection holder part equally from the connection holder part 412.

Referring to FIG. B, the adaptor part 202 may be formed in the cover part 400 including the finned section. That is, the adaptor part 202 may be formed in the center cover part 410 including the finned section.

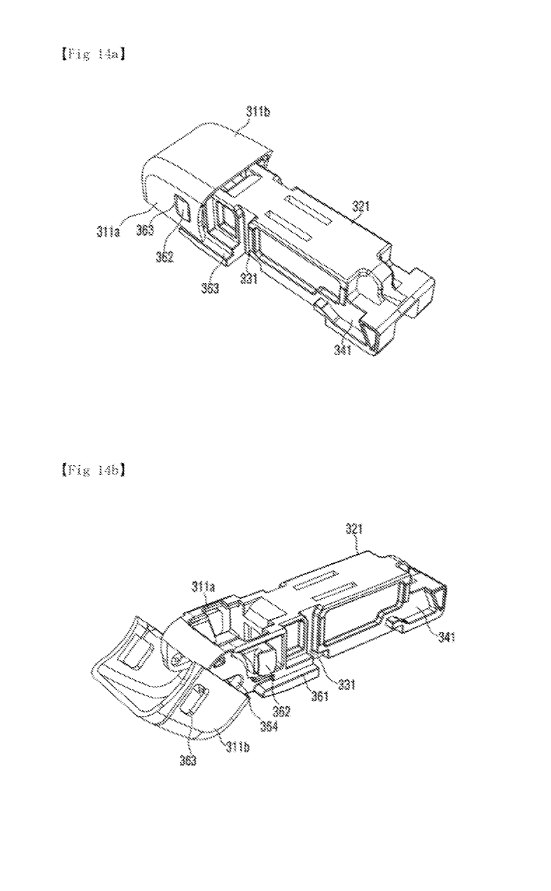

FIG. 13A is a perspective view of the wiper blade according to an embodiment in which an adaptor part 203 is attachable to and removable from the wiper blade 10.

FIG. 13B is a perspective view of the wiper blade with the adaptor part 203 attached thereto.

FIG. 13C is a perspective view of the attachable/removable adaptor part 203 viewed from the bottom.

The adaptor part 203 illustrated in FIGS. 13B and 13C include the fitting recess, the first receiving groove 233, and the second receiving groove 234 same as those included in the adaptor part 200 described in the first embodiment.

The wiper blade 10 includes a seating part 205 in an upper surface of the connection holder part so as to be connected with the attachable/removable adaptor part 203. The seating part 205 is formed in a concave part 245 located approximately in the center of the connection holder part 412 of the cover part 400. The adaptor part 200 is formed in the concave part 245 located approximately in the center of the connection holder part 412 of the cover part 400. It is preferable that the concave part 245 is formed in a trapezoidal shape of which a width becomes narrower in a direction of the wiper strip 600 so that the connection holder part finned section 415a corresponding to a part of the center finned section 415 of the wiper blade is connected with a lower end portion of the connection holder part 412. However, the concave part 245 is not limited to the trapezoidal shape, and may be formed in a U shape.

As illustrated in FIGS. 5 and 8B, the connection holder part 412 includes the finned section 415a extending in a direction of both front ends of the wiper blade 10 from a lower portion. The connection holder part finned section 415a forms the center finned section 415 of the center cover part 410 together with the first lever cover part finned section 415b formed in the first lever cover part 413. The connection holder part finned section 415a spreads pressurizing force to the whole wiper blade 10 by making pressure of traveling wind applied to the wiper blade when the vehicle is driven flow right and left. Accordingly, the adaptor part 203 is formed in the connection holder part 412 including the finned section 415a.

A seating part catching protrusion 206 for a coupling with or a removal from the adaptor part 203 is provided at one side of the adaptor seating part 205. The seating part 205 has an embossing structure for the coupling with the adaptor part 203, and accordingly the adaptor part 203 also has the embossing structure, which makes the seating part 205 and the adaptor part 203 engaged. That is, the adaptor part 203 further includes an embossing part 216 and an adaptor part latch 217 for a coupling with the seating part 205 of the wiper blade 10. When the adaptor part is forwardly pushed after the embossing part 216 and the embossing structure of the seating part 205 are engaged, forward and back movements of the adaptor part latch 217 are restrained by the seating part catching protrusion 206.

In the attachment and the removal of the adaptor part 203, if the adaptor part latch 217 is lifted, the adaptor part 203 is unlocked from the seating part catching protrusion 206 and becomes movable forwardly and backwardly, and then becomes removable upwardly.

A shape of the attachable/removable adaptor part 203 is formed to be connectable with the seating part 205 of the wiper blade, and a shape of an upper surface may be changed according to the coupling with the connector 300. A shape of the connectable connector 300 varies depending on the wiper arm 20, and a shape of the connectable adaptor varies depending on each connector 300. Accordingly, the attachable/removable adaptor part 203 can select the adaptor part and the connector for one wiper blade 10 according to a shape of the wiper arm 20.

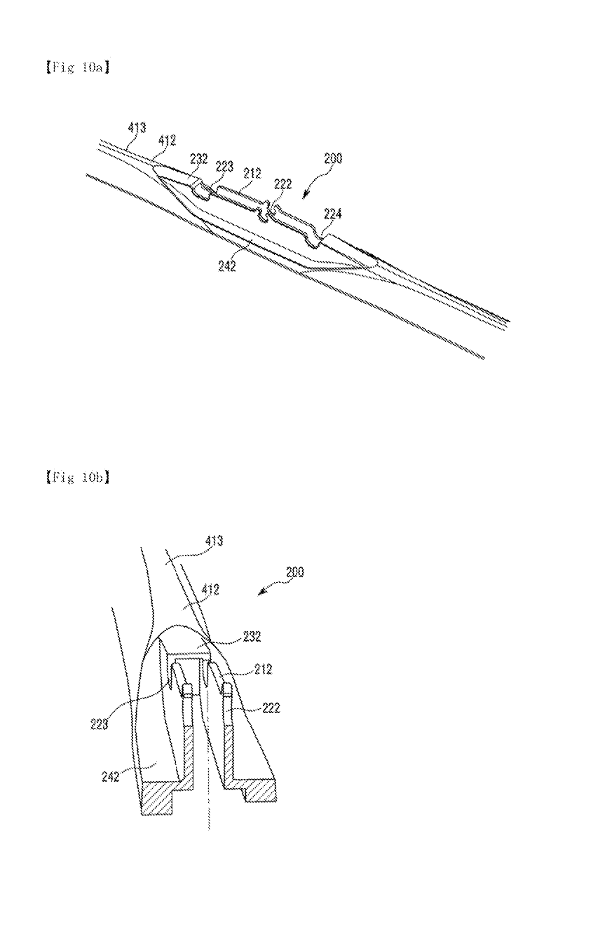

FIGS. 17C and 17D illustrate the adaptor part 203 with the connector 300 mounted thereto. Further, FIG. 9C is a perspective view of the wiper blade in which the adaptor part connectable with the wiper arm 20 in a U-hook type is mounted to the seating part 206 and the connector is coupled to the adaptor part.

Since a shape of the connector 300 coupled with the wiper arm in the U-hook type is the same as a shape of the conventional connector 300, its detailed description will be omitted. A shape of the upper portion of the adaptor part 200 with the connector 300 mounted thereto is the same as a conventional shape, but a bottom surface includes the embossing structure and the adaptor part latch as described above.

As described above, since the adaptor part 203 can be attached and removed, the adaptor part 203 can be coupled with various wiper arms 20 in one wiper blade 10.

Next, an embodiment of the connector will be described.

Prior to describing the embodiment of the connector, a shape of the wiper arm which can be connected to the connector according to the present invention will be described.

FIGS. 9A, 9B, and 9C are views illustrating connection states of the wiper arm 20 applied to an embodiment of the present invention.

FIGS. 9A, 9B, and 9C are partial perspective views illustrating states where the wiper arm in a Bosch type, the wiper atm in a top-lock type, and the wiper arm in the U-hook type are connected to the connector according to the present invention, respectively.

As illustrated in FIGS. 9A, 9B, and 9C, the wiper blade 10 for the vehicle is attachably/removably mounted to the wiper arm 20 connected to a driving source of a vehicle body and configured to transfer rotation power, the wiper arm 20 having a predetermined length. Since the connector 300 is mounted to the wiper blade illustrated in FIGS. 2A and 2B, the wiper illustrated in FIGS. 9A., 9B, and 9C can be coupled to the connector 300. The adaptor part 200 is installed within the connection holder part 412, so that the adaptor part 200 can be assembled with various types of driving arms together with the connector 300 described below.

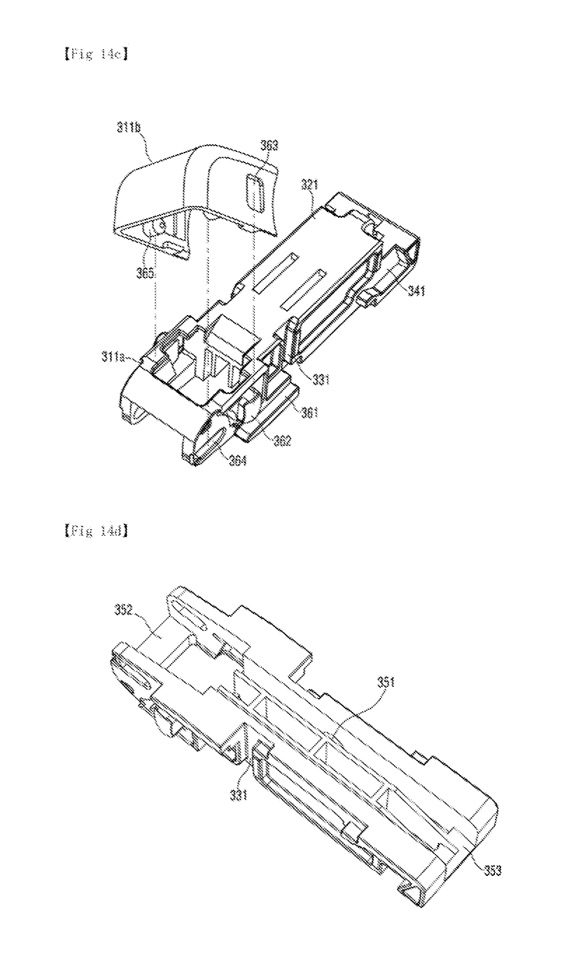

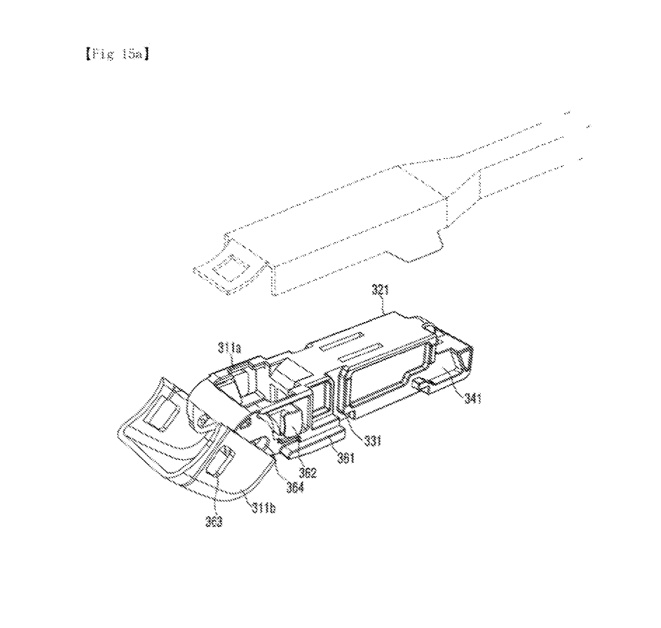

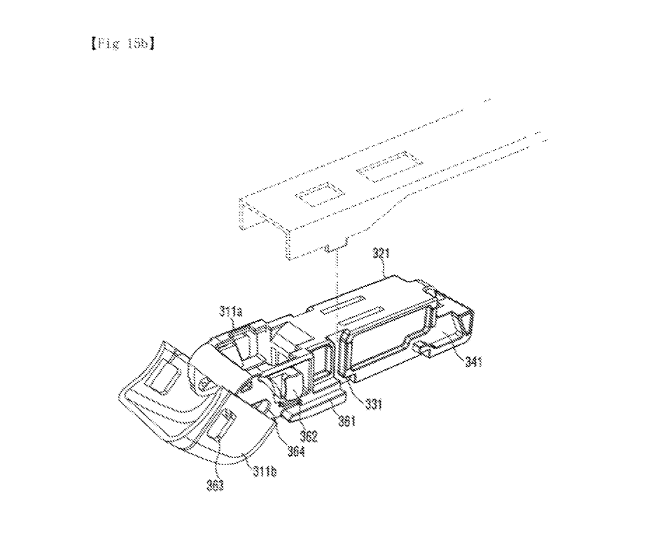

FIGS. 14A, 14B, 14C, and 14D are views illustrating the connector mounted to the adaptor part 200. Referring to FIGS. 10A and 14D, a lower portion of the connector 300 is opened to be coupled with the adaptor part 200. Referring to FIGS. 14A, 14B, 14C, and 14D, the connector includes a connector body 321 and a head part 311.

The connector body 321 includes a fitted part 351 for a coupling with the adaptor part 200, and may include a first coupling part 331 formed in both sides of the connector body 321 for a coupling with the wiper arm in the top-lock type having the latch formed in a front portion of a lower portion of the front end of the wiper arm illustrated in FIG. 9B and a second coupling part 341 for a coupling with the wiper arm having the latch spaced apart from a front end of the wiper arm such as the wiper arm in the Bosch type illustrated in FIG. 9A.

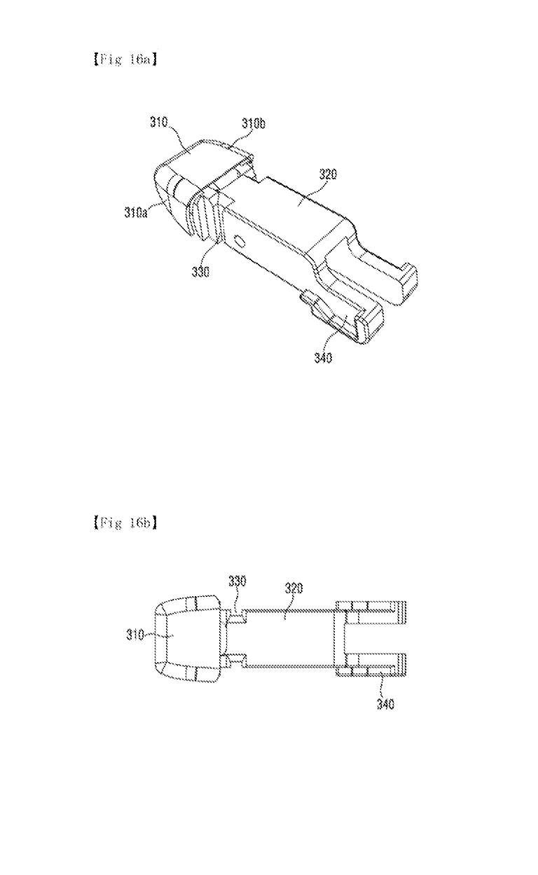

FIGS. 15A and 15B illustrate the wiper blade assembly coupled with various types of wiper arms.

Referring to FIGS. 14B and 14C, the connector head part 311 includes a connector head part body 311a integrally formed with the connector body 321 and a head part cover 311b for covering the head part body 311a.

As illustrated in FIG. 14C, a pair of coupling protrusions 365 and the catching recess 363 for a coupling with the head part body 311a are formed within the head part cover 311b. The pair of coupling protrusions 365 is inserted in the coupling groove 364 provided at the connector head part 311 to guide forward and back movements of the connector head part cover 311b. Further, the coupling protrusion 365 becomes as rotation axis when the head part cover 311b rotates.

The connector head part body may include a guide part 361 for guiding a front and a back of the head part, cover 311b, the coupling groove 364 connected with the coupling protrusion 365 of the head part cover 311b, and an elastic catching piece 362 elastically coupled to the catching recess 363

Referring to FIG. 10A and FIGS. 14A to 14D, the fitted part 351 received in the fitting recess 222 of the adaptor part 200 and configured to mount the connector 300 to the adaptor part 200 is included within a lower portion of the connector 300. The adaptor part 200 is formed of a resin material, and thus the fitting recess 222 elastically receives fitted part 351 of the connector 300, which prevents the connector 300 from being, separated from the adaptor part 200.

Referring to FIGS. 14A to 14D, the first coupling part 331 includes a slot groove formed in the first coupling part 331 for guiding the wiper arm from an upper portion to a lower portion of the connector 300 in order to be connected with the wiper arm in the top-lock type having the catching protrusion and a sliding part formed in the lower portion of the connector 300 supported by the backwardly slid catching, protrusion of the wiper arm 20 guided along the slot groove.

When the catching protrusion of the wiper arm 20 is formed in a center of the wiper arm 20, the second coupling part 341 supports the catching protrusion. The head part 311 is formed in a front of the first coupling part 331 of the connector 300, and includes the head part cover 311b and the head part body 311a. The head part cover 311b covers an upper portion of the head part body 311a The head part cover 311b covers a top of a part of the front end of the wiper arm to prevent the wiper arm from moving forwardly, backwardly, and upwardly. A first lower end part 352 formed in a lower portion of the head part 311 engages with the first receiving groove 223 of the adaptor part 200, and a second lower end part 353 formed in a lower portion of a back end portion of the connector 300 engages with the second receiving groove 224 of the adaptor part 200. The head part cover 311b covers a top of the head part 311.

Referring to FIGS. 10A, 10B, and 10C, and FIGS. 14A to 14D, the coupling between the connector 300 and the adaptor part 200 will be described.

FIG. 17A illustrates a type in which the connector 300 is mounted to the adaptor part 200.

The connector 300 is coupled with the adaptor part 200 from a top to a bottom of the adaptor part 200. The connector 300 includes the fitted part 351 received in the fitting recess 222 of the adaptor center pan 212. The fitting recess 222 of the adaptor center part 212 elastically pressurizes the fitted part 351 in a horizontal direction to prevent the connector 300 from being separated from the adaptor part.

As illustrated in FIG. 15B, the connector 300 is mounted to the adaptor part 200, the wiper arm in the top-lock type which can be connected to the connector 300 includes the fitted part for the coupling with the connector 300, the fitted part being vertically induced along the first coupling part 331 of the connector 300 from a top to a bottom of the first coupling part 331, and the wiper arm is slid toward a back of the connector 300 along a lower end of the first coupling part 331 and rear supported. Further, since the head part 311 of the connector 300 is horizontally fixed, a forward movement of the wiper arm is controlled by the head part cover 310b.

As illustrated in FIG. 15A, the connector 300 includes the second coupling part 341 in order to be coupled with the wiper arm 20 having the fitted part spaced apart from the front end of the wiper arm 20, such as the wiper arm in the Bosch type, by a predetermined distance. The coupling protrusion of the wiper arm is inserted in the second coupling part 341 and thus rear supported. The head part 311 covers the top of the front end of the wiper arm 20. When the head part 311 is horizontally fixed, a rotation and the forward movement of the wiper arm in the Bosch type are controlled.

Referring to FIGS. 14A and 14D, the guide part 361 for enabling the head part cover 311b to slide forwardly and backwardly may be formed in a lower end portion of the connector.

In a case where the wiper arm 20 is coupled to the connector 300, when the wiper arm 20 is coupled with and supported by the first coupling part 331 or the second coupling part 341 formed in sides of the connector 300, the head part cover 311b of the connector 300 is slid toward the back of the connector 300 along the guide part 361, and the elastic catching piece 362 formed in sides of the head part body 311a of the connector 300 is outwardly inserted in and is coupled with the catching recess 363 formed in sides of the head part cover 311b. Accordingly, forward, backward, and upward movements of the wiper arm 20 are restricted.

A process of separating the wiper arm 20 from the wiper blade assembly will be described.

When the elastic catching pieces 362 outwardly inserted in the catching recesses 363 of the head part cover 311b are pressed from both sides and thus released from the catching recess 363, the connector head part cover 311b is forwardly slid along the guide part 361, and can rotate by 90 degrees in a front bottom direction of the connector. When the head part cover 311b of the connector 300 rotates about the coupling protrusion 365 formed in the head part cover 311b, the wiper arm 20 can be separated from the first coupling part 331 or the second coupling part 341

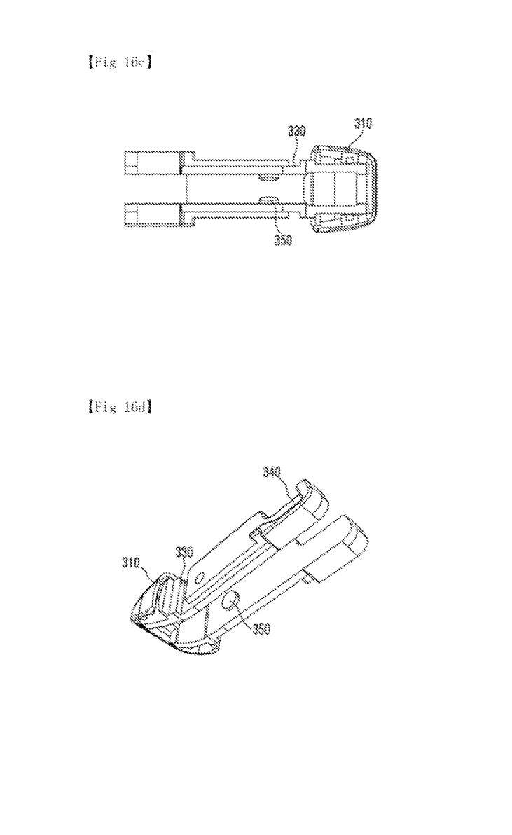

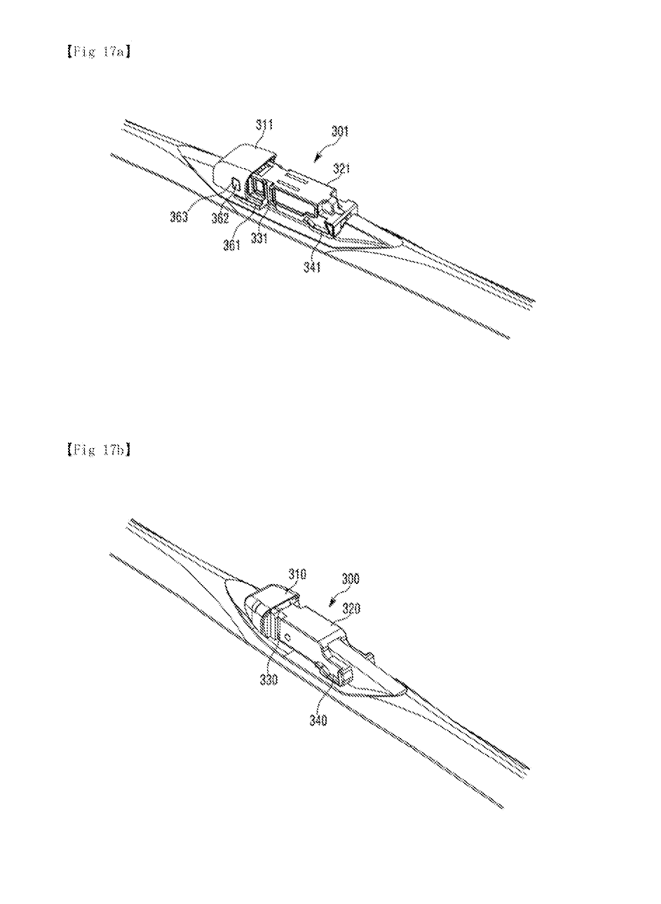

FIGS. 16A to 16D illustrate the connector 300 mounted to the adaptor part 201. Referring to FIGS. 16A to 16D, a lower portion of the connector 300 is opened to be coupled with the adaptor pan 201. Referring to FIGS. 16A to 16D, the connector 300 may include a connector body 320 and the connector head part 310.

The connector body 320 may include a fitted part 350 for a coupling with the adaptor pan 201, a first coupling part 330 for a coupling with the wiper arm in the top-lock, type, and a second coupling part 340 for a coupling with the wiper arm in the Bosch type. The fitted part 350 is received in the fitting recess 220 of the adaptor part 201 illustrated in FIG. 11A. The connector head part 310 may include a head part body 310a and a head part cover 310b. The head part cover 310b can move along a slope of the front end 230 of the concave part 240.

Referring to FIGS. 11A and 16D, the lower portion of the connector 300 is opened to receive the adaptor part 200. An interior of the lower portion of the connector 300 includes the fitted part 350 received in the fitting recess 220 of the adaptor part 200 to mount the connector 300 to the adaptor part 200.

As described in the first embodiment, the first coupling part 331 includes a slot groove formed in the first coupling part 331 for guiding the wiper arm from an upper portion to a lower portion of the connector 300 in order to be connected with the wiper arm in the top-lock type having the fitted part and a sliding part formed in the lower portion of the connector 300 supported by the backwardly slid fitted part of the wiper arm 20 guided along the slot groove. Further, the connector 300 includes the second coupling part 340 in order to be coupled with the wiper arm 20 having the fitted part spaced apart from the front end of the wiper arm 20, such as the wiper aim in the Bosch type, by a predetermined distance. The coupling protrusion of the wiper arm is inserted in the second coupling part 340 and thus rear supported.

The head part 310 is in front of the first coupling part 330 on the connector 300, and the head part 310 includes the head part cover 310b and the head part body 310a. The front end of the head part body 310a is formed to become higher so that the head part 310 engages with the one end 230 of the concave part 240, and the head part cover 310b is formed to cover an upper portion of the head part body 310a. The head part cover 310b covers a top of a part of the front end of the wiper arm 20 to prevent the wiper arm 20 from moving forwardly, backwardly, and upwardly.

The coupling between the connector 300 and the adaptor part 201 will be described with reference to FIGS. 11A and 11B, FIGS. 16A to 16D, and FIG. 17B.

FIG. 17B illustrates that the connector 300 is mounted to the adaptor part 201.

The connector 300 is coupled to the adaptor part 201 from a top to a bottom of the adaptor part 201. The fitted part 350 of the connector 300 is guided by the guide recess 219 and inserted in the fitting recess 220. The guide recess 219 may form a slope of which a horizontal direction width is increased toward the fitting recess 220 from an upper portion of the adaptor part 201. Accordingly, a coupling with the fitting recess of the connector 300 is easily achieved, and the connector 300 is not easily separated.

The connector 300 includes the fitted part 350 received in the fitting recess 220 of the adaptor part 201. The fitted part 350 inserted in the fitting recess 220 of the adaptor part 201 elastically pressurizes the adaptor part 201 in a horizontal direction to prevent the connector 300 from being separated from the adaptor part 201.

Hereinafter, a method of coupling the wiper arm to the connector 300 in a state where the connector 300 is mounted to the adaptor part 201 will be described.

The connector 300 is mounted to the adaptor part 201, and the wiper arm 20 is coupled to the connector 300. The wiper arm in the top-lock type has the catching protrusion for the coupling with the connector 300, is vertically induced along the first coupling part 330 of the connector 300 from a top to a bottom of the first coupling part 330, and is slid toward the back of the connector 300 in the lower end of the connector 300 and rear supported. Further, since the head part 310 of the connector 300 is horizontally fixed, the forward movement of the wiper arm is controlled by the head part cover 310b.

The wiper arm 20 having the latch spaced apart from the front end of the wiper arm 20 such as the wiper arm in Bosch type by a predetermined distance has the coupling protrusion for the coupling with the connector 300, and the connector 300 includes the Bosch coupling part 340 for the coupling with the wiper arm. The coupling protrusion of the wiper arm is inserted in the second coupling part 340 of the connector 300 and rear supported. The head part 310 covers the top of the front end of the wiper arm 20. When the head part 310 is horizontally fixed, the rotation and the forward movement of the wiper arm in the Bosch type are controlled.

The lower end portion of the head part body 310a of the connector is formed to be connected to one end 230 of the concave part 240.

In a case where the wiper arm 20 is coupled to the connector 300, when the wiper arm 20 is coupled with and supported by the first coupling part or the second coupling part formed in sides of the connector 300, the head part cover 310b forwardly and backwardly moves along one end 230 of the concave part 240 to restrain the front end of the wiper arm 20. Accordingly, it is possible to prevent the wiper arm 20 from being, forwardly and upwardly separated.

A method of separating the wiper arm 20 from the wiper blade assembly will be described. The head part cover 310h can forwardly move along the one end 230 of the concave part 240. When the head part cover 311b of the connector 300 forwardly moves, the wiper arm 20 can be separated from the first coupling part 331 or the second coupling pan 332.

The features, structures and effects and the like described in the embodiments are included in at least one embodiment of the present invention and are not necessarily limited to one embodiment. Furthermore, the features, structures, effects and the like provided in each embodiment can be combined or modified in other embodiments by those skilled in the art to which the embodiments belong. Therefore, contents related to the combination and modification should be construed to be included in the scope of the present invention.

Although the present invention has been described based on the preferred embodiment thereof, the embodiment is only illustrative and does not limit the present invention. It can be understood that those skilled in the art can achieve various modifications and applications that are not illustrated herein, without departing from the essential characteristics of the present invention. That is, each component described in the embodiments in detail may be modified and then implemented in various ways. Furthermore, it should be understood that the differences associated with the modifications and applications are included in the scope of the present invention, which is defined in the accompanying claims.

What is claimed is:

1. A wiper blade comprising:
a wiper strip for directly wiping a wiping surface;
a lever assembly for supporting the wiper strip; and
a cover part for receiving the lever assembly, wherein the cover part comprises:
finned sections and integrally formed with the cover part totally concavely in a direction of the wiper strip, the finned section and forming a front end in an upper side of the cover part; and
an adaptor part having a fitting recess approximately in a center thereof to mount the connector.

2. The wiper blade as claimed in claim 1, wherein the cover part further comprises a connection holder part provided approximately at a center thereof, and the connection holder part comprises a connection holder finned section included in a part of the finned sections and the adaptor part.

3. The wiper blade as claimed in claim 2, wherein an upper front end of the connection holder part finned section forms a part of a curve meeting an upper front end of the cover part in a direction of both ends of the wiper strip from a lower end of the connection holder part.

4. The wiper blade as claimed in claim 1, wherein the cover part has a concave part approximately in the center thereof, a lower surface of the adaptor part is formed to fit the concave part, a center part in an upper surface of the adaptor part is protrudely formed, and a fitting recess is provided approximately at a center of the center part.

5. The wiper blade as claimed in claim 4, wherein the concave part has a trapezoidal shape of which a width becomes narrower in a direction of the wiper strip or a U shape.

6. The wiper blade as claimed in claim 4, wherein the center part includes a pair of plate-shaped members facing each other and vertically protruding.

7. The wiper blade as claimed in claim 1, wherein the cover part has a concave part approximately in the center thereof, and one end of the adaptor pan meets one end of the inclined concave part.

8. The wiper blade as claimed in claim 7, wherein the concave part has a trapezoidal shape of which a width becomes narrower in a direction of the wiper strip or a U shape.

9. The wiper blade as claimed in claim 7, wherein the other end of the adaptor part is connected to an upper surface of the cover part.

10. The wiper blade as claimed in claim 1, wherein the cover part has a concave part approximately in the center thereof, a lower surface of the adaptor part is formed to it the concave part, an upper surface of the adaptor part is received in a bottom surface of the connector, at least one pair of connection protrusions for connecting the adaptor part and the connector are protrudely formed in the upper surface of the adaptor part, and the fitting recess is protrudely formed approximately in a center of the adaptor part.

11. The wiper blade as claimed in claim 10, wherein the concave part has a trapezoidal shape of which a width becomes narrower in a direction of the wiper strip or a U shape.

12. The wiper blade as claimed in claim 1, wherein the adaptor pan further comprises an embossing part in a lower portion thereof, and the cover part further comprises a seating part in which the embossing part of the adaptor part is fitted, so that the adaptor part is attachable to/removable from the wiper blade as the embossing pan is fitted in and separated from the seating part.

13. The wiper blade as claimed in claim 12, wherein the adaptor part is provided at a center of the cover part and formed in a connection holder part comprising a connection holder part finned section including a pan of the finned sections.

14. A wiper blade comprising:
a wiper strip for directly wiping a wiping surface;
a lever assembly for supporting the wiper strip; and
a cover part for receiving the lever assembly, wherein the cover part comprises:
a concave part approximately in a center thereof; and
an adaptor part having a fitting recess to mount the connector; and
a lower surface of the adaptor part is formed to fit the concave part, an upper surface of the adaptor part is received in a bottom surface of the connector, at least one pair of connection protrusions for connecting the adaptor part and the connector are protrudely formed in the upper surface of the adaptor part, and the fitting recess is protrudely formed approximately in a center of the adaptor part.

15. A wiper blade assembly comprising:
a wiper strip for directly wiping a wiping surface;
a lever assembly for supporting the wiper strip;
a cover part for receiving the lever assembly, the cover part comprising an adaptor part having a fitting recess approximately in a center thereof; and
a connector comprising a fitted part tined in the fitting recess of the adaptor part, and coupling parts for catching a latch of a wiper arm,
wherein the cover part further comprises finned sections integrally formed with the cover part totally concavely in a direction of the wiper strip, the finned sections forming a front end in an upper side of the cover part.

16. The wiper blade assembly as claimed in claim 15, wherein the cover part further comprises a connection holder part provided approximately at a center of the cover part, and the connection holder part comprises a connection holder part tinned section including a part of the finned sections, and the adaptor part.

17. The wiper blade assembly as claimed in claim 16, wherein an upper front end of the connection holder part finned section forms a part of a curve meeting an upper front end of the cover part in a direction of both ends of the wiper strip from a lower end of the connection holder part.

18. The wiper blade assembly as claimed in claim 15, wherein the cover part has a concave pan approximately in the center thereof, a lower surface of the adaptor part is formed to fit the concave part, a center pan in an upper surface of the adaptor part is protrudely formed, and a fitting recess is provided approximately at a center of the center part.

19. The wiper blade assembly as claimed in claim 18, wherein the concave part has a trapezoidal shape of which a width biomes narrower in a direction of the wiper strip or a U shape.

20. The wiper blade assembly as claimed in claim 18, wherein the center part includes a pair of plate-shaped members facing each other and vertically protruding.

21. The wiper blade assembly as claimed in claim 15, wherein the cover part has a concave part approximately in the center thereof, and one end of the adaptor part meets one end of the inclined concave part.

22. The wiper blade assembly as claimed in claim 21, wherein the concave part 240 has a trapezoidal shape of which a width becomes narrower in a direction of the wiper strip 600 or a U shape.

23. The wiper blade assembly as claimed in claim 21, wherein the other end of the adaptor part is connected to an upper surface of the cover part.

24. The wiper blade assembly as claimed in claim 15, wherein the cover pan has a concave part approximately in the center thereof, a lower surface of the adaptor part is formed to fit the concave part, an upper surface of the adaptor part is received in a bottom surface of the connector, at least one pair of connection protrusions for connecting the adaptor part and the connector are protrudely formed in the upper surface of the adaptor part, and the fitting recess is protrudely formed approximately in a center of the adaptor part.

25. The wiper blade assembly as claimed in claim 24, wherein the concave part has a trapezoidal shape of which a width becomes narrower in a direction of the wiper strip or a U shape.

26. The wiper blade assembly as claimed in claim 15, wherein the adaptor part further comprises an embossing part in a lower portion thereof, and the cover part further comprises a seating part in which the embossing part of the adaptor part is fitted, so that the adaptor part is attachable to/removable from the wiper blade as the embossing part is fitted in and separated from the seating part.

27. The wiper blade assembly as claimed in claim 26, wherein the adaptor part is provided at a center of the cover part and formed in a connection holder part comprising a connection holder part finned section 415a including a part of the finned sections and.

28. A wiper blade assembly comprising:
a wiper strip for directly wiping a wiping surface;
a lever assembly for supporting the wiper strip;
a cover part for receiving the lever assembly, the cover part comprising an adaptor part having a fitting recess to mount a connector; and
the connector comprising a fitted part fitted in the fitting recess of the adaptor part, and coupling parts and for catching a latch of a wiper arm,
wherein the cover part having a concave part approximately in a center thereof, and
the adaptor pan is formed to fit the concave part, an upper surface of the adaptor part is received in a bottom surface of the connector, at least one pair of connection protrusions for connecting the adaptor part and the connector are protrudely formed in the upper surface of the adaptor part, and the fitting recess is protrudely formed approximately in a center of the adaptor part.
